(19) United States
(12) Patent Application Publication
(10) Pub. No.: US 2005/0040643 A1
(43) Pub. Date: Feb. 24, 2005

(54) Variable color print of an image

(76) Inventor: Robert J. Mancuso, Lakeville, MA (US)

Correspondence Address: Iandiorio & Teska, 260 Bear Hill Road, Waltham, MA, 02451-1018, US

(21) Appl. No.: 10/644,413

(22) Filed: Aug. 20, 2003

(51) Int. Cl. B42D 15/00

(52) U.S. Cl. 283/114

(57) ABSTRACT

A variable color print of an image on a substrate with a reflective surface wherein, in one embodiment, a series of parallel differently colored lines are printed and a series of parallel mounds of clear ink are printed over the colored lines of printed ink to vary the reflective angle of the colored lines of printed ink as the viewing angle changes.

### FIELD OF THE INVENTION

This invention relates to a variable color print of an image and a method of making the same.

### BACKGROUND OF THE INVENTION

U.S. Pat. Nos. 6,176,521 and 4,932,685, hereby incorporated herein by this reference, disclose methods of making a variable color print by debossing grooves in a foil layer on a substrate. Periodic colored lines are then printed onto the foil in general alignment with the grooves which, because of the reflective foil, serve as repeated changes in reflectivity that selectively hide or reveal different colors as the viewing angle changes.

U.S. patent application publication No. US 2003/0087072, also incorporated herein by this reference, notes that embossing equipment typically requires a significant capital expenditure and proposes an alternative wherein a substrate is overprinted with a coating in a pattern of lines. The coating includes an additive that lowers the surface tension of the coating which is cured using an electron beam. Then, ink is applied over the printed coating. Because the surface tension of the coating is lower than the surface tension of the substrate, the ink flows away from the coating and towards the areas of the exposed substrate. According to the patent application, the ink thus forms raised ridges. Because the coating is usually clear or translucent, refraction of light through the resin will cause the printed matter to change appearance when viewed at different angles.

This process, however, has not proven commercially successful. And, it may be difficult to control the formation of the ink ridges between the lines of coating material.

The notion of manufacturing variable color print images without embossing, however, is attractive because printing companies do not usually possess engraving (debossing) equipment and if standard printing equipment could be configured to produce the type of print images discussed above, they could be produced in a single run on standard printing equipment using stock paper with a reflective (e.g., foil) surface.

### SUMMARY OF THE INVENTION

It is therefore an object of this invention to produce variable color prints of images without the need to deboss lines in the foil on the substrate.

It is a further object of this invention to provide such images without the need for first applying special coatings that lower the surface tension of the substrate.

It is a further object of this invention to provide a commercially viable method of making variable color prints.

It is a further object of this invention to provide such a method which is reliable and economically feasible.

This invention results from the realization that a suitable variable color print of an image can be produced without the need for debossing equipment by printing mounds of ink on the substrate which produce the different viewing angle/different color effect on the substrate instead of debossing the substrate.

This invention features, in one embodiment, a variable color print of an image comprising a substrate, a series of parallel differently colored lines of printed ink, and a series of parallel printed mounds of clear highly viscous ink over the colored lines of printed ink to vary the reflective angle of the colored lines of printed ink as the viewing angle changes.

In one example, the substrate is paper but it also may be plastic or another transmissive material. A reflective surface such as foil or a reflective ink layer may be disposed between the colored lines of ink and the substrate. Usually, each mound is over at least two different colored lines and there may be lines of differently colored printed ink between the mounds. In one example, there are a plurality of local image regions each including parallel differently colored lines of printed ink and printed mounds of clear ink synchronized with the parallel differently colored lines, wherein different local image regions include parallel lines of printed ink and mounds at different angles.

In another embodiment, a variable color print of an image in accordance with this invention features a substrate, a series of parallel printed mounds of ink on the substrate, and a series of parallel differently colored lines of ink printed on the mounds which vary in reflective angle as the viewing angle changes due to the mounds of ink. In one example, there is a reflective surface on the substrate under the mounds such as a reflective ink layer. In another example, there is a reflective surface on the mounds under the differently colored lines of printed ink.

In still another example, a variable color print of an image in accordance with this invention features a substrate, a series of parallel colored ink mounds printed directly on the substrate and extending in one direction, and at least one series of parallel colored ink mounds printed directly on the substrate and extending in a second, different direction. In one example, the substrate includes a reflective surface and the colored ink of the mounds is transmissive. In another example, the substrate is non-reflective and colored ink of the mounds is reflective. In either example, there may be printed colored lines between the mounds.

One method of producing a variable color print of an image in accordance with this invention features obtaining an image, configuring a printing machine to produce a series of printed ink mounds, printing the ink mounds on a substrate, and printing a series of colored lines synchronized with the printed ink mounds.

In one example, the series of colored lines are printed on the substrate under the ink mounds and the mounds are printed using clear ink. In another example, the series of colored lines are printed on the mounds. One method of producing a variable color print of an image in accordance with this invention features placing a reflective surface on a substrate, printing a series of parallel differently colored lines of ink, and printing a series of parallel mounds of clear ink over the colored lines of printed ink to vary the reflective angle of the colored lines of printed ink as the viewing angle changes. Typically, different local image regions are produced by printing parallel lines of printed ink and mounds at different angles.

In one example, a series of parallel printed mounds of ink are printed on a substrate and a series of parallel differently colored lines of ink are printed on the mounds to vary the reflective angle as the viewing angle changes due to the mound of ink. A reflective surface may be added between the substrate and the mounds. Alternately, a reflective surface can be added between the mounds and the differently colored lines of printed ink.

A variable color print of an image in accordance with this invention may include a substrate, a series of printed mounds of clear viscous ink, and colored ink lines printed on the mounds or printed between the mounds and the substrate. In one example, the substrate includes a reflective surface on which the colored ink lines are printed and the mounds are printed over the lines of colored ink. In another example, the mounds are printed on a reflective surface on the substrate and the colored ink lines are printed on the mounds. In still another example, the mounds are printed on the substrate, the colored ink lines are printed on the mounds, and a printed reflective surface exists between the mounds and the colored ink.

### BRIEF DESCRIPTION OF THE DRAWINGS

Other objects, features and advantages will occur to those skilled in the art from the following description of a preferred embodiment and the accompanying drawings, in which:

FIG. 1 is a schematic enlarged partial top plan view of a variable color print image according to this invention in the form of a cloud generated by several adjacent and differently oriented local regions;

FIG. 2 is an enlarged schematic axonometric view of a portion of line 2-2 of FIG. 1 showing embossed grooves and the lines of colors selectively subdued and revealed at different viewing angles in accordance with the prior art;

FIG. 3 is a schematic three dimensional view showing a portion of a substrate with a series of parallel differently colored lines of printed ink thereon in accordance with this invention;

FIG. 4 is a schematic view of the substrate shown in FIG. 3 with the addition of a series of parallel of printed mounds of clear viscous ink in accordance with the subject invention;

FIG. 5 is a schematic three dimensional view showing another embodiment of the subject invention;

FIG. 6 is a schematic three dimensional view showing still another embodiment of the subject invention;

FIG. 7A is a schematic three dimensional view showing still another embodiment of the subject invention;

FIG. 7B is a top view of still another embodiment of the subject invention; and

FIG. 8 is a schematic three dimensional view showing a pattern of printed ink mounds used to provide a variable color print in accordance with this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

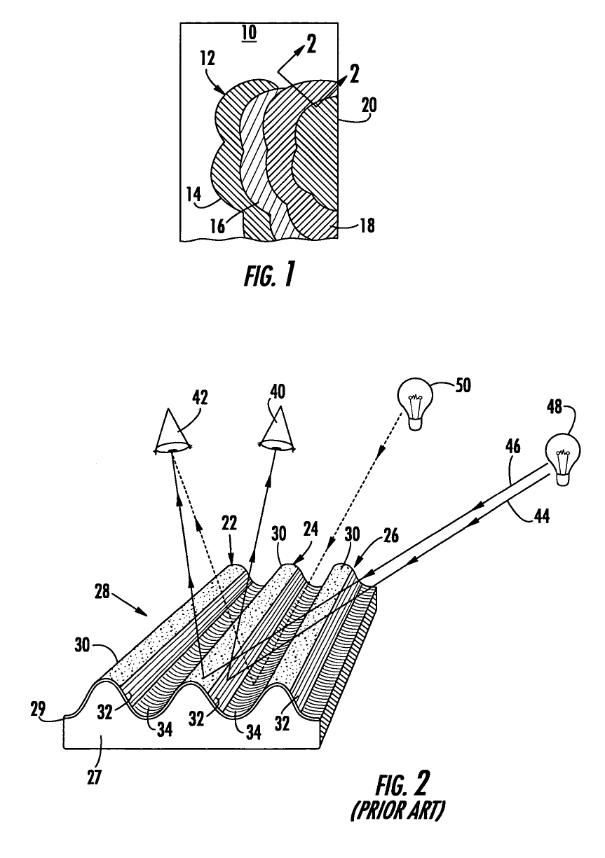

A portion of variable color print 10 according to U.S. Pat. No. 4,932,685 and the subject invention is showing in FIG. 1 in the form of cloud 12 defined in part by local image regions 14, 16, 18, and 20. Each local image region has colored lines oriented in different directions. In the prior art, the lines are established by periodic grooves such as grooves 22, 24, 26 as shown greatly enlarged in FIG. 2. Grooves 22, 24, and 26 are established in substrate 27 such as by heat transfer debossing of foil 29 onto substrate 27. Periodic colors 28 are then printed onto foil 29 in general alignment with grooves 22, 24, and 26 which, because of reflective foil 29, serve as repeated changes in reflectivity that selectively hide or reveal colors 28 as the viewing angle changes.

In this construction, periodic colors 28 may include yellow stripes 30, magenta stripes 32, and cyan stripes 34. Other colors including black and white can be substituted for or provided in addition to these colors.

The effect of changing the viewing angle is shown by the position of observers 40 and 42 in relation to light rays 44 and 46 from light source 48. Groove 24 reflects primarily magenta light from stripe 32 as illuminated by light ray 44 when perceived by observer 40. The cyan color from stripe 30 as illuminated by light ray 46 is reflected at a different angle which is not perceived by observer 40. However, when the viewing angle shifts such as when observer 40 moves to the position occupied by observer 42, the cyan color is perceived instead of the magenta color.

A different viewing angle can also be achieved by shifting the light source to the position occupied by light source 50. At this viewing angle, observer 42 perceives yellow most strongly of all colors 28.

Viewing a color includes perceiving the color in an image region even if the other colors are also visible. A change in viewing angle, such as a change in the angle of illumination or observation, results in a change in the colors perceived as generated by grooves 22, 24, and 26. Referring to FIG. 1, at one viewing angle, regions 14 and 20 appear primarily yellow, region 16 appears primarily cyan, and region 18 appears primarily magenta. Depending on the width of the printed color stripes or lines, a greater or lesser amount of silver foil 29 may also be visible. Typically, the viewing angle is changed by shifting the angle of the paper on which the image is present.

As discussed in the background section above, the goal of the subject invention is to eliminate the need to deboss foil layer 29, FIG. 2 to form grooves 22, 24, 26, and the like in order to achieve the different viewing angle/different color effect.

In one embodiment, this is accomplished by first printing a series of parallel differently colored lines 60, 62, and 64, FIG. 3 of printed ink on reflective surface 66 of substrate 68. Substrate 68 may be paper or a transmissive surface such as plastic. Reflective surface 66 may be foil or a layer of reflective ink printed on substrate 68. FIG. 3 shows one image region as described above greatly exaggerated where line 60 may be yellow, line 62 may be magenta, and line 64 may be cyan.

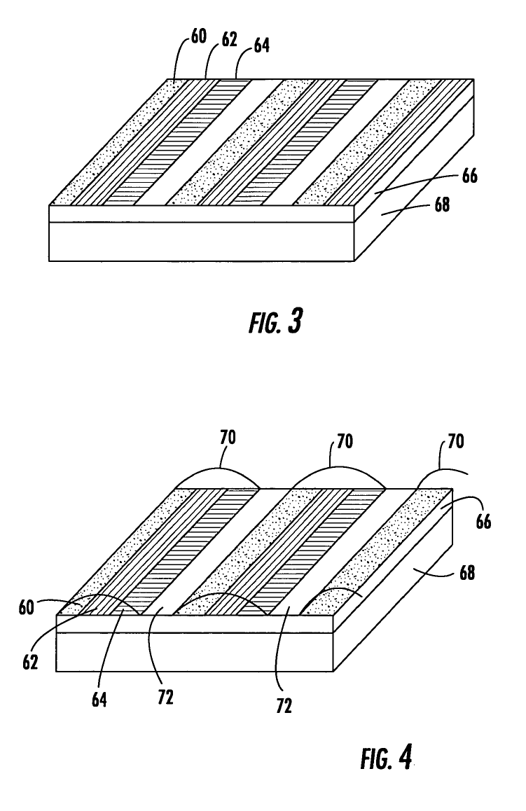

Next, in this embodiment, a series of parallel mounds 70, FIG. 4 of clear ink are printed over the colored lines in a synchronous fashion as shown to vary the reflective angle of the colored lines of printed ink as the viewing angle changes. The result may not be quite as effective as embossing grooves in the foil layer as discussed above with reference to FIG. 2 but the complete process discussed here in with respect to FIGS. 3-4 can be accomplished using a rotogravure or flexography printing press. Alternatively, mounds 70 could be printed using colored but transmissive ink. And, although all the colored lines of FIGS. 3 and 4 extend in the same direction as do the mounds, some mounds and the lines they cover could extend in one direction and other mounds and the lines they cover could extend in a different direction. See FIG. 1.

In one example, the ink used for mound 70, FIG. 4 was a UV resin ink with a viscosity between 1500-3000 cent poise (preferably between 2200-2500) available from Sovereign Specially Chemical Ink (Buffalo, N.Y.). Typically the ink is highly viscous and may be an ultraviolet type ink (e.g., a resin or an ink cured by ultraviolet light) or an ink cured by an electron beam.

Clear ink mounds 70 may cover two or more differently colored lines as shown in FIG. 4 and line 72 between two adjacent mounds may be a colored line of ink or just raw colored foil. As discussed above with reference to FIG. 1, there are typically a plurality of local image regions each including parallel differently colored lines of printed ink and printed mounds of clear ink synchronized with the parallel differently colored lines wherein different local image regions include parallel lines of printed ink and mounds at different angles. Also, if substrate 68 is clear, e.g., plastic, reflective layer 66 may be eliminated if lines 60, 62, and 64 are printed using transmissive colored ink. Clear ink mounds 70 then produce the desired effect when the viewer views the image through the clear substrate 68.

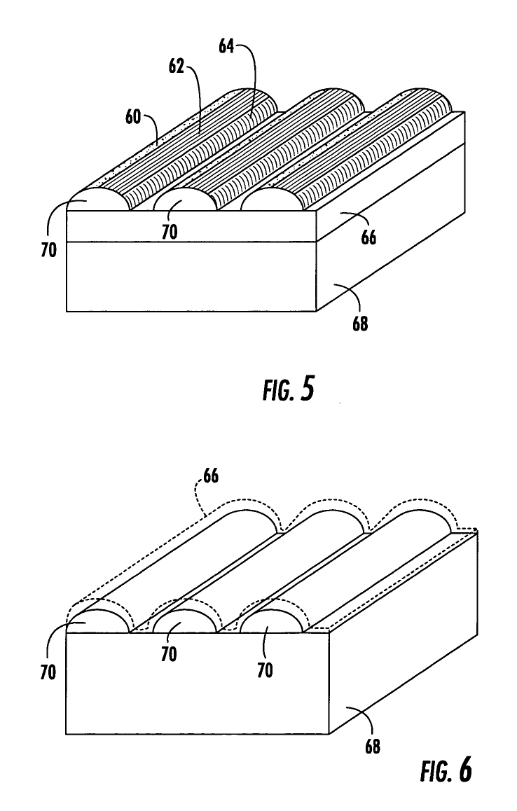

In another embodiment, substrate 68, FIG. 5 includes optional reflective foil or metalization layer 66 and mounds of clear or colored ink 70 printed thereon. Then, one or more parallel differently colored lines 60, 62, and 64 of ink are printed in a synchronized manner on the mounds 70 to vary the reflective angle as the viewing angle changes due to mound 70. Thus, the mounds may be over the colored lines as shown in FIG. 4 or under the colored lines as shown in FIG. 5.

Or, as shown in FIG. 6, mounds of ink 70 are printed directly on substrate 68, foil or reflective ink layer 66 is disposed over the mounds, and in the colored lines of ink (not shown in FIG. 6) are printed on reflective layer 66. The result is the same as FIG. 5 except that there is a reflective layer between the mounds 70 and the printed lines of differently colored ink 60, 62, and 64.

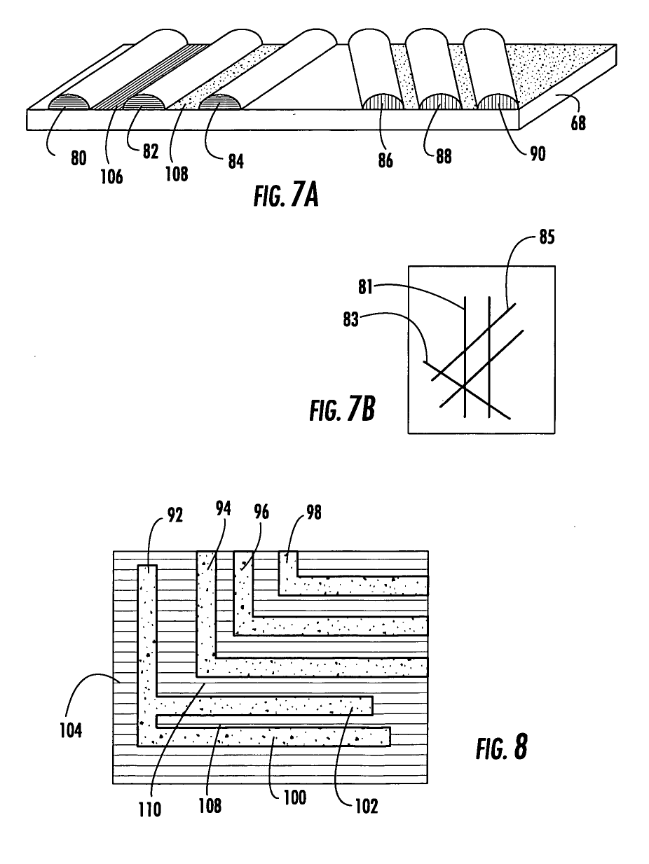

In still another embodiment, parallel mounds of ink 80, 82, and 84 of one color (e.g., blue) and also mounds of ink 86, 88, and 90 of a different color (e.g., magenta), FIG. 7A are printed directly on substrate 68. Mounds 80, 82, and 84 extend in one direction and mounds 86, 88, and 90 extend in another different direction as shown to produce the different viewing angle/different color effect. In FIG. 7B, differently colored mounds 81, 83, 85, etc. or clear mounds printed over differently colored lines extend in different directions as shown to produce the desired effect. As shown in FIG. 8, mounds 92-102 produce a pattern on foil covered substrate 104 but without the need for a special coating as required in U.S. patent publication No. US 2003/0087072.

In this embodiment, the colored ink used to produce the mounds of FIG. 7 or 8 is preferably transmissive and the substrate reflective. Or, the substrate could be non-reflective if the colored ink used to produce the mound is reflective. Differently colored lines 104, 106, etc. FIG. 7 and 108, 110, etc. FIG. 8 can also produce a number of different desired effects.

In accordance with the methods of this invention, an image to be produced to have the multi-colored effect is obtained and a gravure or flexography printing machine is configured based on the image to produce the printed ink mounds discussed above typically by laser engraving the printing cylinder or plate of the printing machine. The highly viscous ink used for the mounds may be cured using ultraviolet light or an electron beam as is known in the art. The masking and other steps associated with producing variable color print images are discussed in the '685 and '521 patents. In a flexography printing machine, the image is photoengraved onto the printing plate and the image area is raised on the plate. Viscous ink is applied to the raised portion of the plate and, as it comes into contact with the substrate, the substrate pulls the ink away from the plate and creates the raised mounds.

The result of the subject invention is the production of variable color prints of images without the need to deboss lines in the foil and without the need for special coatings. The subject invention results in a commercially viable method of making variable color prints which is highly reliable and economically feasible.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A variable color print of an image comprising:
a substrate;
a series of parallel differently colored lines of printed ink; and
a series of parallel printed mounds of clear ink over the colored lines of printed ink to vary the reflective angle of the colored lines of printed ink as the viewing angle changes.

2. The print of claim 1 in which the substrate is paper.

3. The print of claim 1 in which the substrate is plastic.

4. The print of claim 1 in which the substrate is transmissive.

5. The print of claim 1 further including a reflective surface between the lines of printed ink and the substrate.

6. The print of claim 1 in which the reflective surface is a reflective ink layer, a foil layer, or a metalization layer.

7. The print of claim 1 in which each mound is over at least two different colored lines.

8. The print of claim 1 in which there are lines of differently colored printed ink between the mounds.

9. The print of claim 1 in which there are a plurality of local image regions each including parallel differently colored lines of printed ink and printed mounds of clear ink synchronized with the parallel differently colored lines, wherein different local image regions include parallel lines of printed ink and mounds at different angles.

10. A variable color print of an image comprising:
a substrate;
a series of parallel printed mounds of ink on the substrate; and
a series of parallel differently colored lines of ink printed on the mounds which vary in reflective angle as the viewing angle changes due to the mounds of ink.

11. The print of claim 10 further including a reflective surface between the substrate and the mounds.

12. The print of claim 11 in which the reflective surface is a reflective ink layer.

13. The print of claim 10 further including a reflective surface between the mounds and the differently colored lines of printed ink.

14. The print of claim 13 in which the reflective surface is a reflective ink layer.

15. A variable color print of an image comprising:
a substrate;
a series of parallel colored ink mounds printed directly on the substrate and extending in one direction; and
at least one series of parallel colored ink mounds printed directly on the substrate and extending in a second, different direction.

16. The print of claim 15 in which the substrate includes a reflective surface.

17. The print of claim 16 in which the colored ink of the mounds is transmissive.

18. The print of claim 15 in which the substrate is non-reflective.

19. The print of claim 18 in which the colored ink of the mounds is reflective.

20. The print of claim 15 further including printed colored lines between the mounds.

21. A method of producing a variable color print of an image, the method comprising:
obtaining an image;
configuring a printing machine to produce a series of printed ink mounds;
printing the ink mounds on a substrate; and
printing a series of colored lines synchronized with the printed ink mounds.

22. The method of claim 21 in which the series of colored lines are printed on the substrate under the ink mounds and wherein the mounds are printed using clear ink.

23. The method of claim 21 in which the series of colored lines are printed on the mounds.

24. A method of producing a variable color print of an image, the method comprising:
placing a reflective surface on a substrate;
printing a series of parallel differently colored lines of ink; and
printing a series of parallel mounds of clear ink over the colored lines of printed ink to vary the reflective angle of the colored lines of printed ink as the viewing angle changes.

25. The method of claim 24 further including producing different local image regions by printing parallel lines of printed ink and mounds at different angles.

26. A method of producing a variable color print of an image, the method comprising:
printing a series of parallel printed mounds of ink on a substrate; and
printing a series of parallel differently colored lines of ink on the mounds to vary the reflective angle as the viewing angle changes due to the mound of ink.

27. The method of claim 26 further including the step of adding a reflective surface between the substrate and the mounds.

28. The method of claim 26 further including the step of adding a reflective surface between the mounds and the differently colored lines of printed ink.

29. A method of producing a variable color print of an image, the method comprising:
printing a series of parallel colored ink mounds on a substrate to extend in one direction; and
printing a series of parallel colored ink mounds on a substrate to extend in a second, different direction.

30. The method of claim 29 in which the color of the ink mounds printed in the first direction are different in color then the series of ink mounds printed in the second direction.

31. The method of claim 29 in which both series of ink mounds are in the same region.

32. the method of claim 29 in which the colored ink mounds are transmissive and each mound is disposed over differently colored lines of ink on the substrate.

33. A variable color print of an image comprising:
a substrate;
a series of printed mounds of clear ink having a viscosity when printed of between 1500-3000 cent poise; and
colored ink lines printed on the mounds or printed between the mounds and the substrate.

34. The print of claim 33 in which the substrate includes a reflective surface on which the colored ink lines are printed.

35. The print of claim 34 in which the mounds are printed over the lines of colored ink.

36. The print of claim 33 in which the mounds are printed on a reflective surface on the substrate and the colored ink lines are printed on the mounds.

37. The print of claim 33 in which the mounds are printed on the substrate, the colored ink lines are printed on the mounds, and further including a printed reflective surface between the mounds and the colored ink.
